(19) United States
(12) Patent Application Publication
(10) Pub. No.: US 2010/0119097 A1
(43) Pub. Date: May 13, 2010

(54) MICROPHONE DEVICE AND MANUFACTURING METHOD THEREOF

(75) Inventor: Yoshio OHTSUKA, Kanagawa (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/610,811

(22) Filed: Nov. 2, 2009

Related U.S. Application Data
(63) Continuation of application No. PCT/JP2008/002181, filed on Aug. 8, 2008.

(30) Foreign Application Priority Data
Aug. 10, 2007 (JP) P2007-209123

(51) Int. Cl. H04R 9/08

(52) U.S. Cl. 381/361

(57) ABSTRACT

The present invention provides a microphone device with good frequency characteristics. The microphone device can pick up sound faithfully. In detail there is provided a microphone device comprising a microphone element, a signal processor, and a cover disposed over the microphone element and the signal processor, the cover including a mesh structure occupying 25% or more of at least one surface of the cover.

### BACKGROUND OF THE INVENTION

1. Field of the Invention

The present invention relates to a microphone device and a manufacturing method thereof, and particularly to a microphone device with excellent frequency characteristics.

2. Description of the Background Art

A cover is conventionally used in order to protect an electronic component such as a chip mounted on a substrate from powder dust or electromagnetic-wave noise, etc. from the outside.

FIG. 10 shows an outline perspective view of a conventional MEMS microphone. FIG. 11A is a side view of the conventional MEMS microphone.

FIG. 11B is a plan view of the conventional MEMS microphone. FIG. 11C is a cross-sectional view taken along line A-A in FIG. 10, showing the conventional MEMS microphone.

The conventional MEMS microphone 300 shown in FIGS. 10 and 11A to 11C includes a substrate 301, a MEMS chip 200 and a cover 303. Here, the MEMS chip 200 is a chip constructing a microphone element for converting a sound signal into an electrical signal.

Such a MEMS microphone 300 is mounted on a main substrate of, for example, a mobile telephone. In this case, in order to ensure a passage of the sound signal, the microphone is mounted so that an aperture in the mobile telephone overlaps with an aperture 303c in a top portion 303a of the cover. Also, the MEMS microphone 300 is bonded to the substrate 301 through an adhesive 303c at the end 303d of a side portion 303b (for example, see JP-A-2000-165998).

### SUMMARY OF THE INVENTION

In such a conventional MEMS microphone, it was found that frequency characteristics of the microphone have a disadvantage of having an output around a region of 12 kHz larger than one at 1 kHz by about 10 dB or more. In the conventional microphone, there is a peak (maximal point) of frequency characteristics around a region of 12 kHz.

Essentially, the microphone desires flat frequency characteristics in order to pick up sound faithfully, but the microphone having such a peak of frequency characteristics has a problem of being difficult to pick up sound faithfully because a high region (region of a high frequency) is pronounced.

This is probably because a sound pressure (pressure change according to the vibration of air by sound) applied to a vibrating plate becomes large at a resonance point since a chamber (front air chamber) formed between an aperture in the cover and the vibrating plate serves as a resonator.

The present invention has been implemented in view of the problem described above, and an object of the present invention is to provide a microphone device which has good frequency characteristics and can pick up sound faithfully.

In accordance with the present invention, there is provided a microphone device, comprising: a microphone element comprising a Si substrate, a vibrating film electrode formed on the substrate, a fixed electrode over the vibrating film electrode and a cavity between the vibrating film electrode and the fixed electrode, a signal processor, a printed circuit board, the microphone element and the signal processor disposed thereon; and a cover, the cover and the printed circuit board define an interior portion including the microphone element and the signal processor therein, wherein the cover including a mesh structure occupying 25% or more of at least one surface of the cover.

By this configuration, at least the part of the cover comprises an acoustically-transmissive conductive structure, so that the microphone device can be constructed so as not to construct a resonator causing the resonance described above. Also, in the case of being attached to a mobile telephone etc., there is no need the aperture in the cover is aligned with that of the mobile telephone and the microphone device is attached to the mobile telephone easily.

In a capacitor microphone element (MEMS microphone element) manufactured using a microfabrication technique (MEMS technique) of silicon LSI, processing accuracy is higher than that of a microphone element manufactured by assembly of mechanical components and accuracy of acoustoelectric conversion is high and stable. Using this advantage, a microphone element manufactured by a semiconductor manufacturing process is covered by the cover and a microphone device (microphone module) is constructed. However, the cover tends to construct a Helmholtz resonator. To solve the problem, the present invention provides the microphone device comprising the cover of which frequency characteristics are improved by constructing a structure in which a Helmholtz resonance frequency does not occur at an audible frequency range. Consequently, stable frequency characteristics with high accuracy can be achieved by covering the microphone element with the cover having an acoustically-transmissive conductive structure.

In addition, a signal processor may herein be constructed so as to make only impedance conversion.

That is, by this configuration, the present invention solves the disadvantage described above by adjusting frequency characteristics of a microphone and setting a resonance frequency which is a peak out of an audible frequency range (20 Hz to 20 kHz).

The resonance frequency is given by the following formula by a principle of Helmholtz resonance.

$$\begin{matrix}[ Formula 1 ] & \\ {f}_{r} = \frac{c}{2 π} \sqrt{\frac{π {d}^{2}}{4 V ( l + 0.6 d )}} = \frac{c}{2 π} \sqrt{\frac{s}{V {d}^{′}}} & ( Formula 1.1 )\end{matrix}$$

where, fᵣ is a resonance frequency; c is a sound speed; π is the circular ratio; d is a diameter of an aperture in the cover; V is volume of a front air chamber; l is a length of the aperture in the cover (i.e., thickness of the cover); s is an area of the aperture in the cover; and d′ is l+0.6d.

In the case of l<<0.6d, d′≈0.6d is satisfied, so that the following formula is derived from formula 1.1.

fᵣ∝\sqrt{d} (Formula 1.2)

Also, s∝d² is satisfied, so that the following formulas are derived from formula 1.1 and formula 1.2 in the case of l<<0.6d.

$${f}_{r} ∝ \sqrt[4]{s} \qquad ( Formula 1.3 )$$

Also, when formula 1.4 is satisfied, formula 1.3 can also be applied to the cover where an aperture does not construct one hole. In the cover where the aperture constructs many holes, s is the total area of many holes.

When formula 1.4 is satisfied, formula 1.3 indicates that, in other words, a resonance frequency becomes high in proportion to a fourth root of the area of the aperture.

For example, there is a conventional microphone device which has a resonance frequency of 12 kHz. According to the present invention, s (the area of the aperture in the cover) of the present invention is 16 times as large as that of the conventional microphone device (now, formula 1.4 is satisfied). By this configuration, the resonance frequency of the present invention doubles and can be set at 24 kHz which is out of the audible range, thus the disadvantage described above can be solved.

Also, for example, there is a conventional microphone device for which a length of the aperture (i.e., thickness of a cover) is 0.1 mm, a diameter of the aperture is 0.6 mm, an area of a surface having the aperture formed in the cover is 12 mm², and a resonance frequency is 12 kHz. According to the present invention, the aperture ratio of the surface having the aperture in the cover is set at 25% or more. In other words, a mesh structure occupies 25% or more of at least one surface (in particular, the surface having the aperture) of the cover. By this configuration, the resonance frequency can be set out of the audible range, thus the disadvantage described above can be solved.

A diameter of the aperture, in other words, the width of the aperture is determined according to the volume of a front air chamber so as to satisfy formula 1.

For example, Firstly, a diameter d1 of an aperture for, for example, 20 kHz<fᵣ is obtained. Next, a diameter d of an aperture of the present invention is set to be larger than d1. As the result, a resonance point presents out of an audible frequency range, thus Helmholtz resonance can be avoided.

For example, when d=2 mm is set in formula 1 described above, fᵣ becomes 24 kHz and a resonance point is out of the audible frequency range.

Also, when d=2 mm and an aperture area S=3 mm² are set and the size of a surface having the aperture formed in a cover are set at substantially 3×4, the aperture ratio of the surface having the aperture formed in the cover could be about 25%.

That is, the aperture ratio of the surface having the aperture could be constructed so as to become 25% or more. An upper limit of the aperture ratio depends on a mechanical strength of a material. That is, the aperture ratio could be determined within a range capable of maintaining the mechanical strength.

The present invention includes the microphone device, wherein the shape of the cover is a rectangular parallelepiped shape, and at least a part of a surface of the cover opposed to the microphone element includes an acoustically-transmissive conductive structure

By this configuration, Helmholtz resonance can be avoided efficiently.

The present invention includes the microphone device, wherein the acoustically-transmissive conductive structure is formed by a conductive material having multiple holes.

By this configuration, occurrence of Helmholtz resonance can be suppressed by a space or a size of a hole, so that design is also easy.

The present invention includes the microphone device, wherein the acoustically-transmissive conductive structure comprises a mesh structure.

By this configuration, the microphone device is manufactured easily and it is easy to suppress occurrence of Helmholtz resonance by adjusting a size of a wire material which forms a mesh, so that design is also easy. Also, the mesh forms a part of the cover, so that it is desirable to have a shielding effect of electromagnetic-wave noise as well as guiding sound from a sound source to a microphone element. Hence, the mesh is formed by a conductive material (metal) and an electromagnetic shield effect is obtained.

The present invention includes the microphone device, wherein the acoustically-transmissive conductive structure comprises a punching metal (in other words, the perforated structure).

It is preferable that the present invention includes the microphone device comprising a microphone element comprising a Si substrate, a vibrating film electrode formed on the substrate, a fixed electrode over the vibrating film electrode and a cavity between the vibrating film electrode and the fixed electrode, a signal processor, a printed circuit board, the microphone element and the signal processor disposed thereon; and a cover, the cover and the printed circuit board define an interior portion including the microphone element and the signal processor therein, wherein the cover including a perforated structure occupying 25% or more of at least one surface of the cover.

By this configuration, occurrence of Helmholtz resonance can be suppressed efficiently by a space or a size of a hole while maintaining a mechanical strength by adjusting a punch for punching (in other words, the hole of the perforated structure), so that design is also easy.

The present invention includes the microphone device, wherein the acoustically-transmissive conductive structure comprises a sintered metal.

By this configuration, the microphone device is manufactured easily.

The present invention includes the microphone device, wherein the acoustically-transmissive conductive structure comprises a porous conductive material.

By this configuration, the microphone device is manufactured easily.

The present invention includes the microphone device, wherein the microphone and the signal processor are integrated inside the common substrate.

According to the configuration described above, miniaturization can be achieved while reducing transmission loss by integrating and forming a microphone element and a signal processor inside the common substrate. Desirably, LSI of the microphone element and the signal processor is performed and also its LSI is covered with a cover having multiple holes formed by a MEMS process and thereby, a very compact microphone device with excellent resonance frequency characteristics can be obtained. Also, further miniaturization can be achieved by this configuration.

It is preferable that the present invention includes the microphone device comprising: a microphone element, a signal processor; and a cover disposed over the microphone element and the signal processor, the cover including an aperture whose size is decided so that a resonant frequency presents out of audible frequency range.

The present invention includes the microphone device, wherein the substrate is disposed so as to be opposed to the acoustically-transmissive conductive material via a spacer, and the substrate and the conductive material have the same outer shape.

By this configuration, multiple microphone devices can be formed easily by a wafer level CSP. By using an acoustically-transmissive conductive material, in the case of being attached to a mobile telephone etc., there is no need the aperture in the cover is aligned with that of the mobile telephone and the microphone device is attached to the mobile telephone easily

The present invention includes the microphone device, wherein the cover is formed by processing a semiconductor substrate by an MEMS process.

By this configuration, using photolithography, an aperture having the desired diameter and aperture ratio can be formed in the cover easily, and a magnetic shield effect can also be maintained high. According to the configuration described above, further miniaturization and thinning can be achieved.

In accordance with the present invention, there is provided a method of manufacturing a microphone device, including the steps of: forming a microphone element using a semiconductor manufacturing process; forming a signal processor for performing predetermined arithmetic processing based on an output signal of the microphone element; forming a cover, at least a part of the cover having an acoustically-transmissive conductive structure; and disposing the cover over the microphone element and the signal processor.

The present invention includes the method of manufacturing the microphone device, wherein the step of forming the cover includes a step of forming multiple holes in a metal plate by punching (forming a perforated structure).

The present invention includes the method of manufacturing the microphone device, wherein the step of forming the cover includes a step of forming a mesh structure in the cover by a metal material.

The present invention includes the method of manufacturing the microphone device, including a step of integrating and forming the microphone element and the signal processor inside the common substrate.

The present invention includes the method of manufacturing the microphone device, including the steps of: forming plural sets of microphone elements and signal processors on a semiconductor wafer; aligning a metal plate having multiple holes with the semiconductor wafer, and bonding the metal plate to the semiconductor wafer via a spacer, so as to form a bonded body; and dividing the bonded body along a dicing line, wherein a microphone device including at least one of the microphone elements and at least one of the signal processors is formed.

The present invention includes the method of manufacturing the microphone device, wherein the step of forming the bonded body includes the steps of: forming multiple holes by performing punching process in a metal plate and forming a projection part used as a spacer by performing folding process; and bonding the projection part to the semiconductor wafer.

According to the present invention, by disposing a cover comprising an acoustically-transmissive conductive structure over a MEMS microphone element with high accuracy and excellent stability manufactured using a MEMS technique, Helmholtz resonance at an audible frequency range can be avoided and flat frequency characteristics can be obtained and faithful sound pickup can be achieved easily even at a high region.

In other words, Helmholtz resonance at an audible frequency range can be avoided by a mesh structure formed in a cover.

Also, a one-modularized microphone device capable of performing stable sound pickup with high accuracy can be obtained by receiving a signal processor in addition to the microphone element inside the cover.

Also, a shielding effect of electromagnetic-wave noise can be obtained by forming a conductive mesh.

Also, a microphone device in which attachment to a mobile telephone etc. is facilitated, and positioning is facilitated in the case of mounting is implemented.

Moreover, an extremely miniature microphone device with excellent frequency characteristics can be provided by mounting a cover by a wafer level CSP.

### BRIEF DESCRIPTION OF THE DRAWINGS

FIG. 1 is a sectional view showing a microphone device of a first embodiment of the present invention.

FIG. 2 is a sectional view of a device for explaining a structure of a microphone element (MEMS microphone element) manufactured by a manufacturing process of silicon LSI shown in FIG. 1.

FIG. 3 shows a microphone device of a second embodiment of the present invention.

FIG. 4 shows a microphone device of a third embodiment of the present invention.

FIG. 5 shows a microphone device of a fourth embodiment of the present invention.

FIGS. 6A and 6B show a manufacturing step of the microphone device of the fourth embodiment of the present invention.

FIGS. 7A and 7B show a manufacturing step of the microphone device of the fourth embodiment of the present invention.

FIG. 8 shows a mobile telephone using a microphone device of a fifth embodiment of the present invention.

FIG. 9 is a sectional view taken on line A-A of FIG. 8.

FIG. 10 is a sectional view showing a structure of a conventional example.

FIGS. 11A to 11C are sectional views showing the structure of the conventional example.

FIG. 12 shows frequency characteristics of microphone devices of a conventional example and embodiments of the present invention respectively.

### DETAILED DESCRIPTION OF THE PREFERRED EMBODIMENTS

Next, embodiments of the present invention will be described with reference to the drawings.

### First embodiment

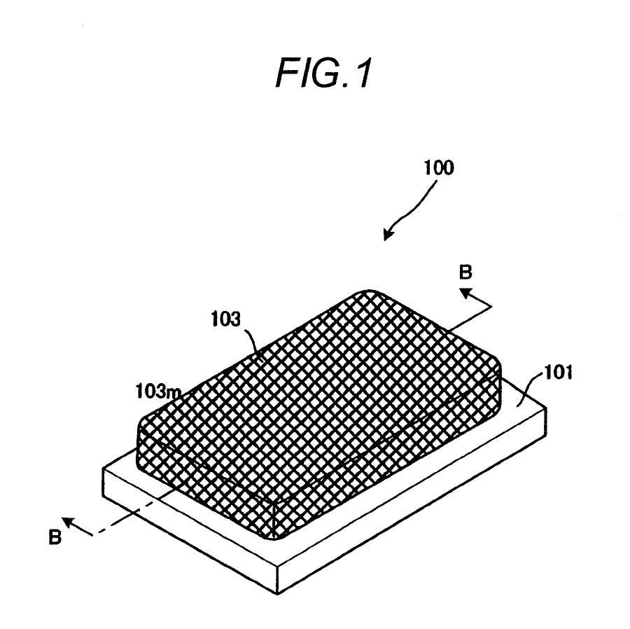

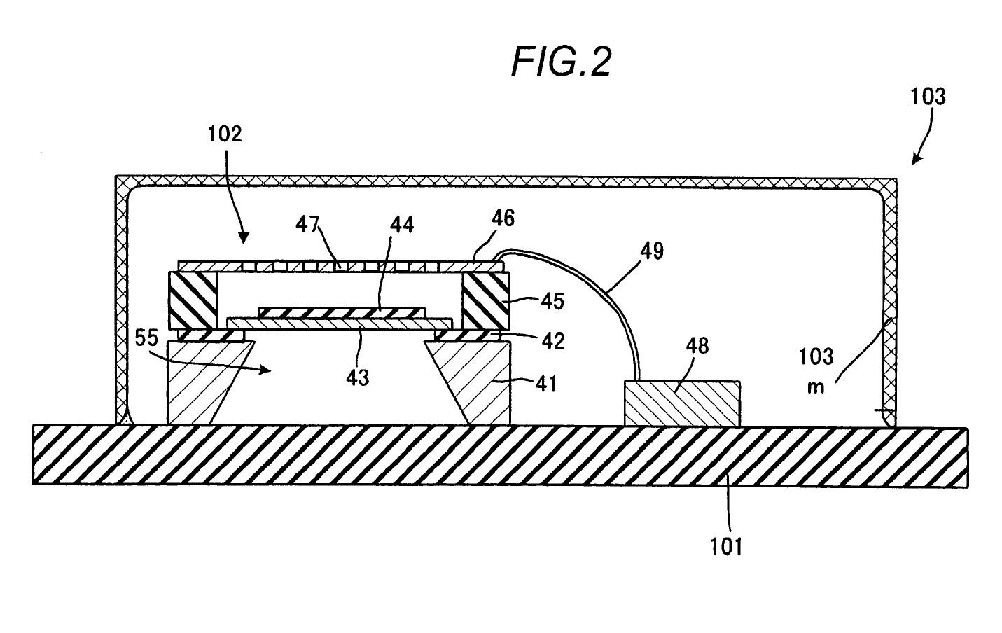

FIG. 1 shows an outline perspective view of an MEMS microphone 100 of the first embodiment. FIG. 2 shows a longitudinal sectional view (sectional view taken on line B-B of FIG. 1) of the MEMS microphone 100. As shown in FIGS. 1 and 2, the MEMS microphone 100 has a substrate 101, a MEMS chip 102 and a cover 103. FIGS. 1 and 2 are sectional views showing an example of the cover comprising an acoustically-transmissive mesh structure, and FIG. 2 is a sectional view showing a microphone element of a MEMS structure used herein.

This microphone device includes a microphone element manufactured using a semiconductor manufacturing process, a signal processor for performing predetermined arithmetic processing based on an output signal of the microphone element, and a cover 103 comprising an acoustically-transparent (acoustically-transmissive) mesh structure over the microphone element and the signal processor, and preventing Helmholtz resonance at an audible frequency range as shown in FIG. 1. Reference numeral 101 is a substrate on which the sound pickup element and the signal processor are mounted.

As shown, the microphone device of the embodiment adopts a cover having an acoustically-transparent (acoustically-transmissive) mesh structure as the cover 103.

Sounds essentially go straight and a diffraction phenomenon does not occur unless path interference under a predetermined condition occurs. Hence, the whole cover comprises an acoustically-transparent (acoustically-transmissive) mesh structure (this mesh has a structure having multiple holes with diameters of the extent to which a bad influence by diffraction of sound is not caused) and sound arriving from a sound source go straight as they are and reach each of the microphone elements. In addition, the whole cover comprises the mesh structure (mesh structure 103m) herein, but the mesh structure is disposed corresponding to the microphone element. It is preferable that a mesh structure may be formed only in a region opposed to a microphone element. Also, the cover 103 may be constructed by a sintered body made of nitride etc. or oxide of metal or (sintered) metal such as titanium, nickel or chromium. In this case, the cover 103 may be constructed by a porous sintered conductive material having holes in a part or all of the cover.

Consequently, sounds from the sound source go straight as they are and reach microphone element without being blocked by the cover 130 of the microphone device. That is, sound can be picked up faithfully without a bad influence caused by Helmholtz resonance.

Also, a shielding effect of electromagnetic-wave noise can be obtained by a mesh structure formed by processing a material such as metal having conductivity.

The substrate 101 is a printed circuit board on which the MEMS chip 102 is mounted. The size of a mounting surface of the substrate 101, the microphone element mounting thereon, is substantially 3×4 mm (3 mm long and 4 mm wide).

The MEMS chip 102 is a chip for converting a sound signal captured by a vibrating film electrode 43 into an electrical signal as shown in FIG. 2. Concretely, the MEMS chip 102 has the vibrating film electrode 43 and an electret film 44 on a silicon substrate 41 (a first insulating layer 42 is interposed therebetween) and also has a fixed electrode 46, in which apertures 47 are formed,and a second insulating layer 45 is formed between the fixed electrode and the substrate. Also, a back air chamber 55 formed by etching the silicon substrate 41 is formed at the side of a back surface of the vibrating film electrode 43. The MEMS (Micro Electro Mechanical System) chip is an electromechanical element chip constructed by a minute component formed using a microfabrication technique of a semiconductor.

The vibrating film electrode 43 is formed by doped polysilicon having conductivity and the electret film 44 is formed by a silicon nitride film or a silicon oxide film and also, the fixed electrode 46 is constructed by doped polysilicon, a silicon oxide film and a silicon nitride film which are laminated.

Also, an amplifier 48 for amplifying an electrical signal from the MEMS chip 102 is electrically connected to the MEMS chip 102 by a wire 49. The MEMS chip 102 and the amplifier 48 are covered with the cover 103.

The microphone device is manufactured as below. Firstly, a semiconductor chip 48 as a signal processor for performing predetermined arithmetic processing based on an output signal of a microphone element is formed while forming the MEMS chip 102 as the microphone element using a semiconductor manufacturing process. Next, these chips are mounted on the substrate 101 and are connected electrically by wire, the cover 103 comprising a metal mesh structure is attached to the substrate 101

In a capacitor microphone element (MEMS microphone element) manufactured using a microfabrication technique (MEMS technique) of silicon LSI, processing accuracy is higher than that of a microphone element manufactured by assembly of mechanical components and accuracy of acoustoelectric conversion is high and stable. Using this advantage, a microphone element manufactured by a semiconductor manufacturing process is covered by the cover 103 and a microphone device (microphone module) is constructed. However, when this cover constructs a resonance chamber, frequency characteristics reduces and sound cannot be picked up faithfully, so that the cover having a mesh structure is adopted in the embodiment.

In the embodiment, Helmholtz resonance does not occur at an audible frequency range because the microphone device has a cover in which an acoustically-transmissive mesh structure is formed.

### Second Embodiment

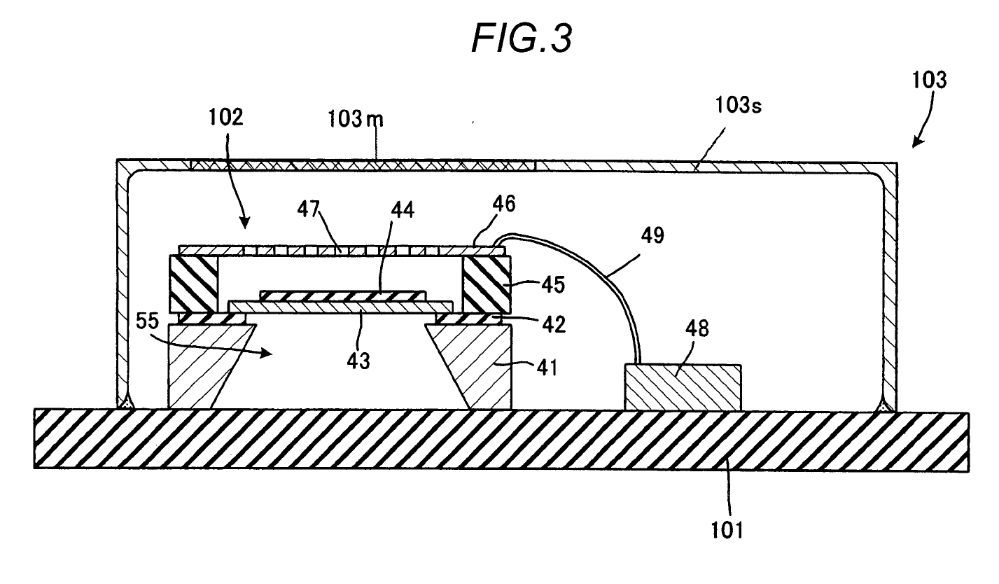

FIG. 3 is a sectional view showing another example of a microphone device of the present invention. In FIG. 3, the same numerals are assigned to portions common to the diagram described in the first embodiment.

The whole surface of the cover of the first embodiment shown in FIG. 2 is constructed by the mesh structure, but in the present embodiment, a mesh structure 103m is disposed corresponding to a MEMS chip 102 and the other region including a side surface is made of a metal substance as shown in FIG. 3.

The other portions than the cover are formed in a manner similar to the first embodiment. Here, the mesh structure 103m is disposed in an opening formed in the cover body 103s, and is bonded using an adhesive. The opening is formed in the cover so as to make sounds arrive at a vibrating plate of the microphone element.

For example, the mesh structure 103m is formed using a coarse mesh sheet (cloth). As the coarse mesh sheet, a knit-shaped mesh comprising stitches in which a conductive stringy material is knitted or a punching mesh sheet in which fine small holes are bored in a thin metal sheet, etc. can be used and a width of one pitch of its mesh coarseness is suitably about 0.5 mm to 5.0 mm.

By forming at least a part of the cover 103 in an acoustically-transparent (acoustically-transmissive) mesh structure thus, a situation in which the inside of the cover is formed in a resonance chamber is avoided and faithful sound pickup characteristics can be obtained.

Also, a shielding effect of electromagnetic-wave noise can be obtained by forming a conductive mesh.

### Third Embodiment

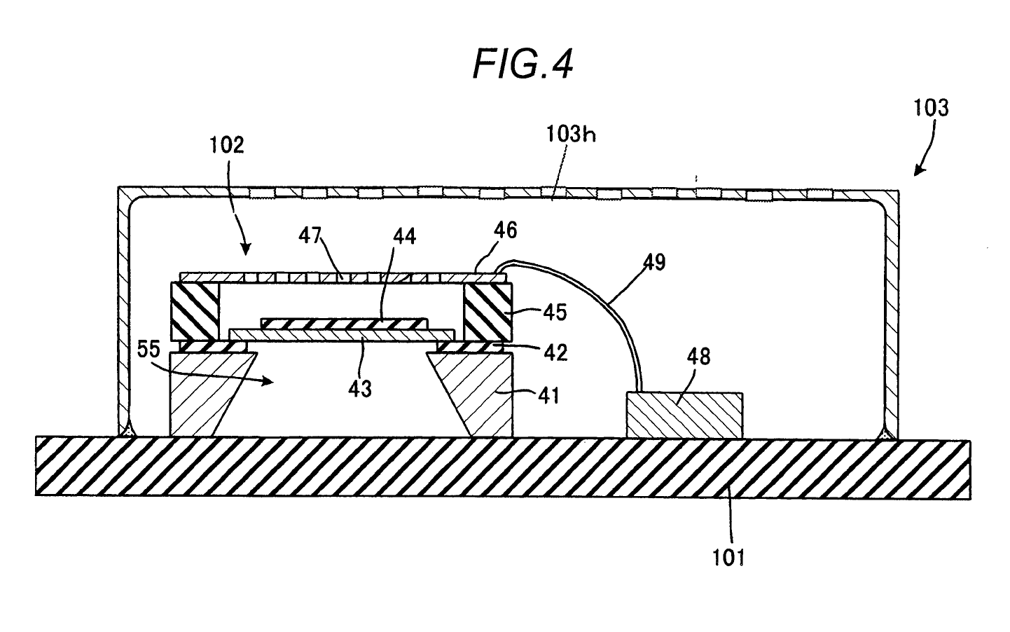

FIG. 4 is a sectional view showing another example of a microphone device of the present invention. In FIG. 4, the same numerals are assigned to portions common to the diagrams described in the first and second embodiments.

The whole surface of the cover of the first embodiment shown in FIG. 2 is constructed by the mesh structure, but the embodiment is characterized in that a cover 103 has a punching metal (perforated structure) in which holes 103h are formed in a region opposed to a MEMS chip 102 as shown in FIG. 4.

The other portions than the cover are formed in a manner similar to the first embodiment.

The holes 103h are formed so as to become, for example, an aperture ratio of 25% or more.

Here, in the case of being constructed so that an audible frequency is set at 20 hHz and a parameter such as an aperture width d is obtained so as to become larger than this audible frequency and a resonance point becomes larger than its aperture width d, Helmholtz resonance does not occur.

This resonance frequency is given by the following formula as described above.

$$\begin{matrix}[ Formula 2 ] & \\ {f}_{r} = \frac{c}{2 π} \sqrt{\frac{π {d}^{2}}{4 V ( l + 0.6 d )}} = \frac{c}{2 π} \sqrt{\frac{s}{V {d}^{′}}} & ( Formula 1.1 )\end{matrix}$$

where, fᵣ is a resonance frequency; c is a sound speed; r is the circular ratio; d is a diameter of an aperture; V is volume of a front air chamber; l is a length of the aperture (i.e., thickness of the cover); s is an area of the aperture; and d′is l+0.6d.

In the case of l<<0.6d, d′0.6d is satisfied, so that the following formula is derived from formula 1.1.

fᵣ∝\sqrt{d} (Formula 1.2)

Also, s∝d² is satisfied, so that the following formulas are derived from formula 1.1 and formula 1.2 in the case of l<<0.6d.

$${f}_{r} ∝ \sqrt[4]{s} \qquad ( Formula 1.3 )$$

l<<1.2\sqrt{s/π} (Formula 1.4)

For example, when d=2 mm is set in formula 1.1 described above, fᵣ becomes 24 kHz and a resonance point is outside an audible frequency range.

Also, when d=2 mm and an aperture area S=3 mm² are set and the size of a surface having the aperture is substantially 3×4 mm, an aperture ratio of a surface having the aperture could be about 25%.

That is, the aperture ratio of a surface having the aperture could be 25% or more. An upper limit of this aperture ratio depends on a mechanical strength of a material. That is, the aperture ratio could be determined within a range capable of maintaining the mechanical strength.

A resonance frequency is shown in the following table 1 when using the microphone device of the present invention.

TABLE 1

| | | Unit | | Unit |
|---|---|---|---|---|
| c | 340 | m/sec | | |
| π | 3.141593 | | | |
| d | 2 | mm | 0.002 | M |
| V | 12 | mm³ | 0.000000012 | mm³ |
| I | 0.1 | mm | 0.0001 | M |
| fᵣ | 24.28352 | kHz | | |

On the other hand, it is shown in the following table 2 when using a conventional microphone device.

TABLE 1

| | | Unit | | Unit |
|---|---|---|---|---|
| c | 340 | m/sec | | |
| π | 3.141593 | | | |
| d | 0.6 | mm | 0.0006 | M |
| V | 12 | mm³ | 0.000000012 | mm³ |
| I | 0.1 | mm | 0.0001 | M |
| fᵣ | 12.24689 | kHz | | |

By forming a structure having an accoustically-transparent (acoustically-transmissive) opening in at least a part of the cover 103 thus, a situation in which a resonance chamber is formed in the inside of the cover is avoided and faithful sound pickup characteristics can be obtained.

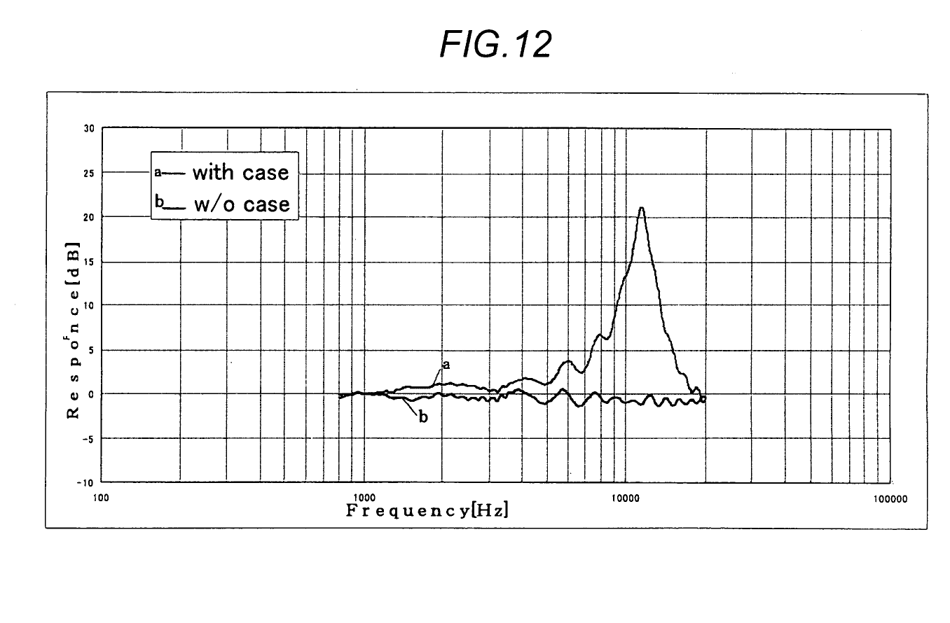

FIG. 12 shows frequency characteristics of a conventional microphone device and the microphone device of the present invention respectively. The cover of the conventional microphone device does not have the mesh structure, thus in the conventional microphone device Helmholtz resonance occurs. Reference sign ‘a’ shows frequency characteristics of the conventional microphone device. On the other hand, the cover of the microphone device of the present invention has the acoustically-transmissive conductive structure, thus in the microphone device of the present invention Helmholtz resonance does not occur. Reference sign ‘b’ shows frequency characteristics of the present invention. By the cover comprising an acoustically-transmissive conductive structure as described in the present invention, as shown by the curve ‘b’, Helmholtz resonance does not occur at a usable frequency range in the cover, thus faithful sound pickup can be achieved.

Also, a shielding effect of electromagnetic-wave noise can be obtained by forming a hole in a conductive base substance.

Also, the cover 103 may be constructed so that a porous material is impregnated with a solvent including metal particles. Or, the cover may be constructed so that a material including conductive particles such as metal is molded and thus cover has porous.

In addition, in the embodiment described above, a microphone element chip and a signal processing circuit chip are formed by being mounted on a substrate, but LSI of MEMS microphone elements with high accuracy and excellent stability may be performed in a parallel arranged state. Moreover, a cover made of silicon in which fine holes are formed by a photolithography process in an MEMS process using the same silicon substrate as an LSI chip in which a microphone element and a signal processing circuit are installed as a start material may be adopted.

### Fourth Embodiment

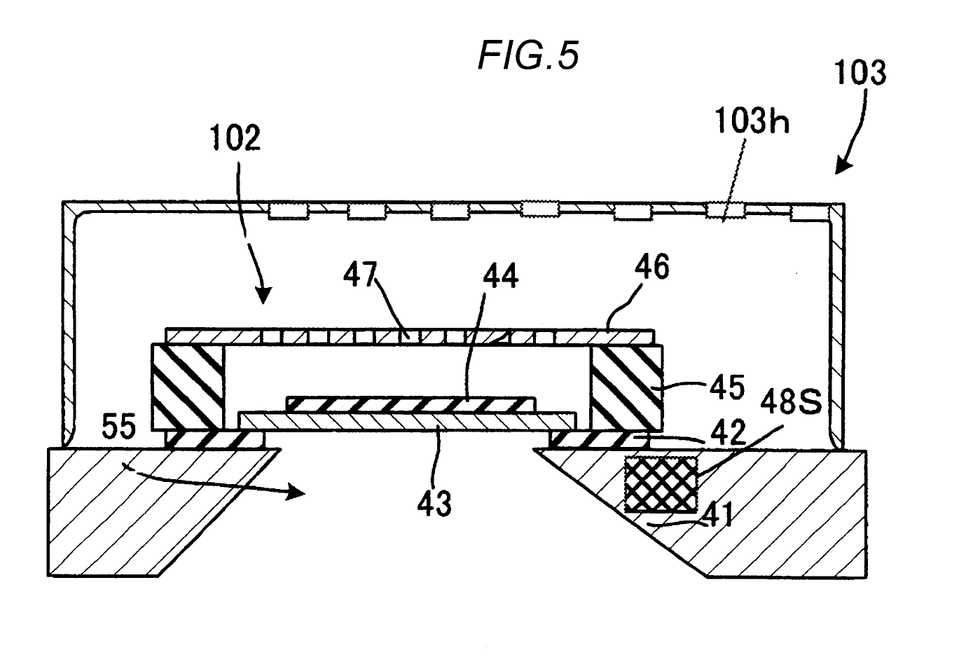

FIG. 5 is a sectional view showing a microphone device of a fourth embodiment of the present invention. In FIG. 5, the same numerals are assigned to portions common to the diagram described in the first embodiment.

The present embodiment is characterized in that LSI of a microphone element chip and a signal processing circuit chip is performed and a MEMS chip formed on the same silicon substrate is accommodated in a cover 103 constructed by a punching metal.

A MEMS chip 102 is a chip for converting a sound signal captured by a vibrating film electrode 43 into an electrical signal in a manner similar to the MEMS chip 102 of the first embodiment shown in FIG. 2, and is formed in a manner similar to the first embodiment except that an electronic circuit such as an amplifier 48S as a signal processing circuit is integrated into this chip, and the same numerals are assigned to the same portions.

Also, an amplifier 48 for amplifying an electrical signal of the MEMS chip 102 is electrically connected to a fixed electrode 46 through a through hole (not shown). Also, the MEMS chip 102 in which this amplifier 48S is also integrated is covered with the cover 103 constructed by the punching metal.

The microphone device is manufactured as below.

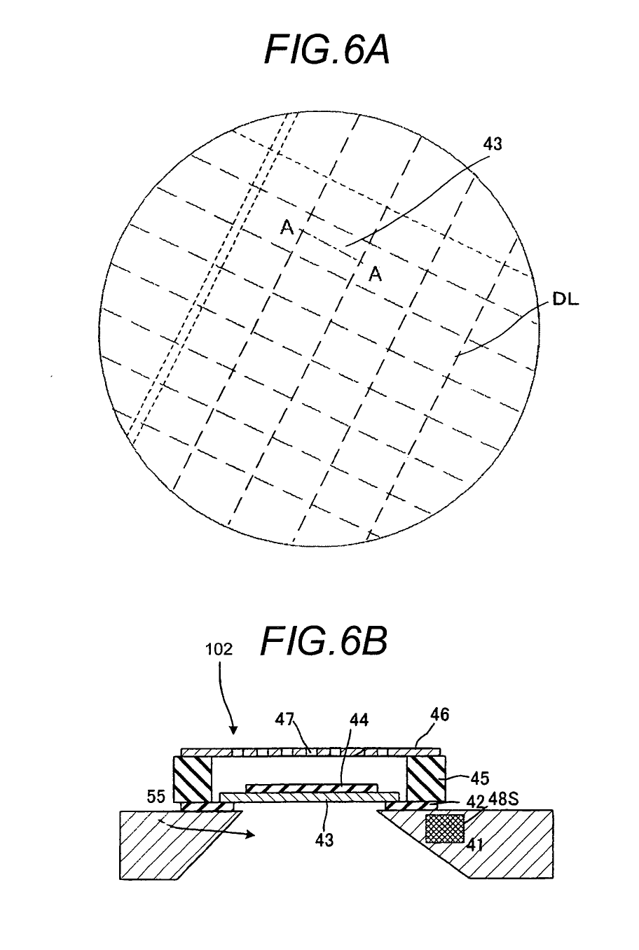

As shown in FIGS. 6A and 6B, many element regions are formed in a silicon wafer 1. In each of the element region a signal processing circuit such as the amplifier 48S and a microphone element are integrated using a semiconductor manufacturing process. FIG. 6B is a cross-sectional view taken along line A-A in FIG. 6A, showing the microphone element comprising the amplifier 48S. As shown in FIGS. 6A and 6B, a region 43 surrounded by dicing lines DL corresponds to the MEMS chip 102.

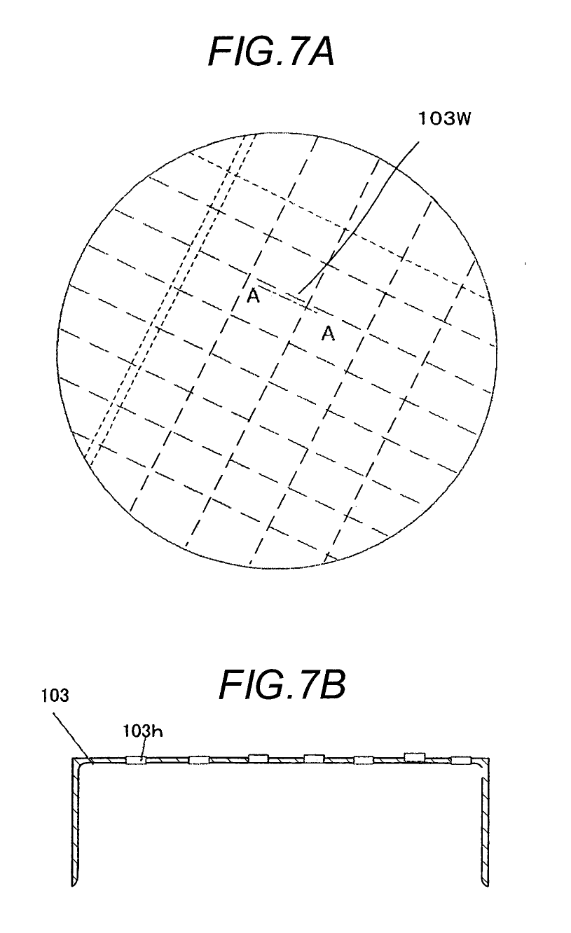

On the other hand, as shown in FIGS. 7A and 7B, punching holes (perforated structure) 103h are formed by punching a metal plate 103W corresponding to the silicon wafer. FIG. 7B shows the cover 103 which is formed by processing the metal plate 103W shown in FIG. 7A. As shown in FIGS. 7A and 7B, a region surrounded by lines corresponding to dicing lines DL shown in FIG. 6A is the cover 103. Processing the metal plate 103W comprises the step of forming protrusion portion corresponding to the MEMS chip 102.

Next, the silicon wafer 1 is bonded to the metal plate 103W with an adhesive. In this case, the dicing lines of the silicon wafer 1 is aligned and overlapped with those of the metal plate 103W.

Next, it is divided into individual microphone devices along the dicing lines. As the result, the microphone device shown in FIG. 5 is completed.

According to this configuration, the microphone device having faithful sound pickup characteristics can be obtained extremely easily. Also, the device is a microphone device of a chip size, so that an extremely fine outer shape can be obtained.

In addition, in the embodiment described above, the punching metal is used as the cover, but a mesh structure may be constructed by a metal material and be mounted in like manner.

Also, in the case of forming a body of bonding between a silicon wafer in which a microphone element and a signal processing circuit are formed and a metal plate of a wafer level in which shape processing of a punching metal is performed, the metal plate in which the protrusion part is formed using the metal mold is used, but a spacer may be formed by other member or a projection part used as a spacer may be formed by performing folding processing.

### Fifth Embodiment

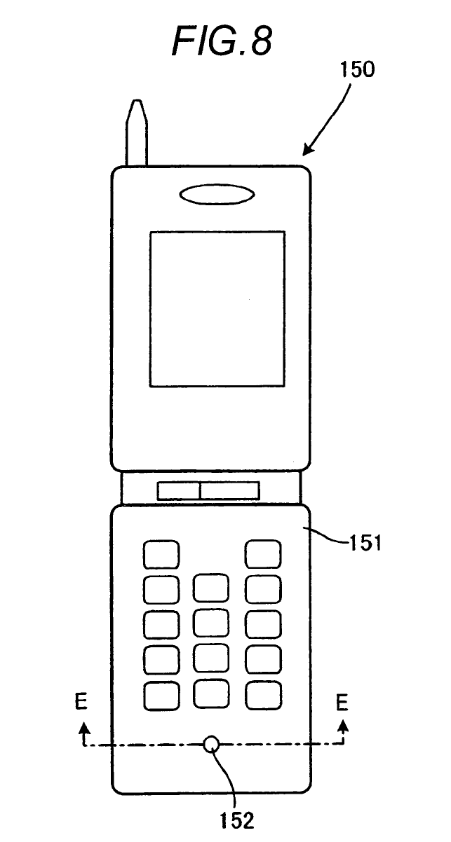

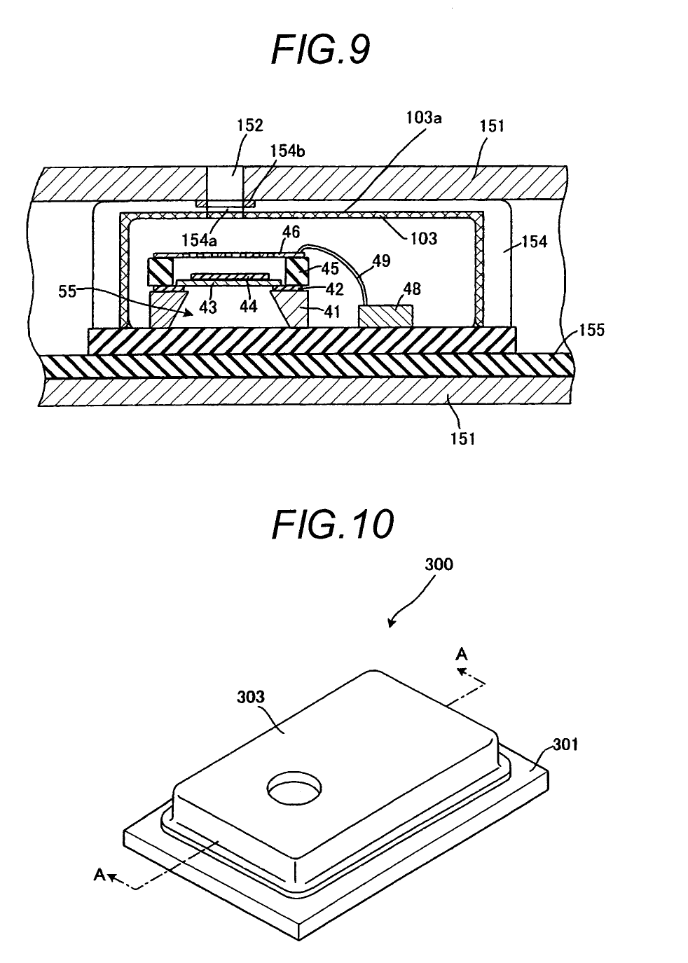

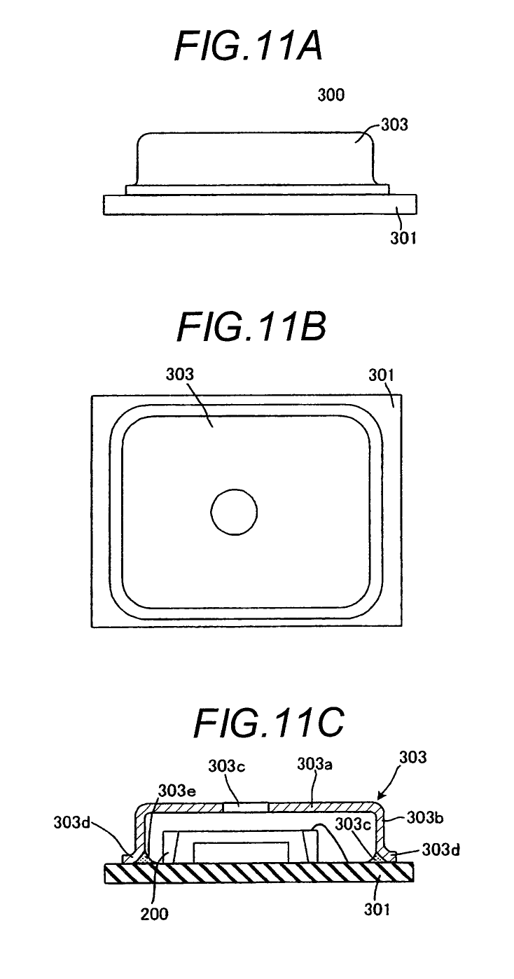

An example of using a MEMS microphone 100 of the present invention in a mobile telephone will be described. FIG. 8 is an outline perspective view of a mobile telephone 150 in which the MEMS microphone 100 is installed. FIG. 9 is a main sectional view (sectional view taken on line E-E in FIG. 8) of the vicinity of a microphone part of the mobile telephone 150.

In a cabinet 151 of the mobile telephone 150 shown in FIG. 8, an aperture in the mobile telephone 152 for microphone is formed in a position in the vicinity of a mouth of a user.

A gasket 154 is sandwiched between an inside surface of the cabinet 151 and a top portion 103a of a cover of the MEMS microphone 100. As shown in FIG. 9, a cover 103 (103m) of a metal mesh structure is positioned in the periphery of the aperture 152 in the cabinet 151, so that in the case of being attached to a mobile telephone etc., there is no need the aperture in the cover is aligned with that of the mobile telephone.

Also, a hole 154a is formed in the gasket 154 with substantially the same shape as aperture formed in the mobile telephone 152. Also, an acoustic resistance material 154b is formed in the end of the cabinet side of the hole 154a. This acoustic resistance material 154b reduces a propagation speed of a sound signal, and performs a function of adjusting acoustic characteristics of the MEMS microphone 100 herein.

A thickness of the gasket 154 is slightly thicker than a gap between the inside surface of the cabinet 151 and the top portion of the cover 103a and the gasket 154 is sandwiched in close contact from the cover 103 to the end of the top portion 103a.

In other words, as a region in which the gasket 154 is sandwiched, a distance from an aperture 103c in the cover to each end of the top portion 103a is designed to respectively have a spacing of 1 mm or more, so that airtightness after the gasket 154 is sandwiched is ensured.

Therefore, a sound signal entering from the aperture 152 in the cabinet does not leak in the gap between the inside surface of the cabinet 151 and the top portion 103a and acoustic characteristics of the MEMS microphone 100 are not damaged.

The sound entering from the aperture 152 in the cabinet passes through the acoustic resistance material 154b and passes through the cover 103 of the metal mesh structure and propagates to a vibrating film electrode 43 of an MEMS chip. Capacitance of a plate capacitor constructed by the vibrating film electrode 43 and a fixed electrode 46 varies and the sound is fetched as a change in voltage.

According to this configuration, the miniaturized MEMS microphone 100 can be installed in a mobile telephone, so that a shape of the whole mobile telephone 150 can be miniaturized and thinned.

Thus, without adding a special step and requiring high-accuracy alignment, mounting can be performed with extremely good workability and the miniature MEMS microphone device 100 with high reliability can be obtained.

The present invention can form a microphone device which has excellent sound pickup characteristics and avoids Helmholtz resonance at an audible frequency range by an extremely simple configuration, so that the present invention is useful as a microminiature microphone device (for example, a microminiature electret capacitor microphone array module).

What is claimed is:

1. A microphone device comprising:
a microphone element comprising a Si substrate, a vibrating film electrode formed on the substrate, a fixed electrode over the vibrating film electrode and a cavity between the vibrating film electrode and the fixed electrode,
a signal processor,
a printed circuit board, the microphone element and the signal processor disposed thereon; and
a cover, the cover and the printed circuit board define an interior portion including the microphone element and the signal processor therein,
wherein the cover includes a mesh structure occupying 25% or more of at least one surface of the cover.

2. The microphone device according to claim 1, wherein the mesh structure is disposed in an aperture formed in the cover.

3. The microphone device according to claim 1, wherein the microphone element is a MEMS element formed by a semiconductor manufacturing process.

4. The microphone device according to claim 3, wherein the MEMS element is an acoustic element which converts sound pressure into an electrical signal.

5. The microphone device according to claim 1, wherein a size of the printed circuit board is substantially 3×4 mm.

6. The microphone device according to claim 1, wherein the mesh structure is disposed corresponding to the microphone element.

7. The microphone device according to claim 1, wherein the mesh structure is a conductive material.

8. The microphone device according to claim 1, wherein the mesh structure is made of a metal.

9. The microphone device according to claim 1, wherein the entire cover comprises the mesh structure.

10. A microphone device comprising:
a microphone element comprising a Si substrate, a vibrating film electrode formed on the substrate, a fixed electrode over the vibrating film electrode and a cavity between the vibrating film electrode and the fixed electrode,
a signal processor,
a printed circuit board, the microphone element and the signal processor disposed thereon; and
a cover, the cover and the printed circuit board define an interior portion including the microphone element and the signal processor therein,
wherein the cover includes a perforated structure occupying 25% or more of at least one surface of the cover.

11. The microphone device according to claim 10, wherein the perforated structure comprises apertures formed in the cover.

12. The microphone device according to claim 11, wherein the microphone element is a MEMS element formed by a semiconductor manufacturing process.

13. The microphone device according to claim 12, wherein the MEMS element is an acoustic element which converts sound pressure into an electrical signal.

14. The microphone device according to claim 10, wherein a size of the printed circuit board is substantially 3×4 mm.

15. The microphone device according to claim 10, wherein the perforated structure is disposed corresponding to the microphone element.

16. The microphone device according to claim 10, wherein the perforated structure is a conductive material.

17. The microphone device according to claim 10, wherein the perforated structure is made of a metal.

18. The microphone device according to claim 10, wherein the perforated structure is formed in an entire upper surface of the cover.

19. A microphone device comprising:
a microphone element;
a signal processor; and
a cover disposed over the microphone element and the signal processor, the cover including an aperture whose size is selected such that a resonant frequency of said microphone device is outside of audible frequency range.

20. The microphone device according to claim 19, wherein the resonant frequency of the microphone device is more than 20 KHz.
